(19) United States
(12) Patent Application Publication
(10) Pub. No.: US 2015/0050564 A1
(43) Pub. Date: Feb. 19, 2015

(54) SECONDARY BATTERY

(71) Applicant: KABUSHIKI KAISHA TOYOTA JIDOSHOKKI, Kariya-shi, Aichi (JP)

(72) Inventors: Kayo Mizuno, Kariya-shi (JP); Keiichi Hayashi, Kariya-shi (JP); Yoshikatsu Kawabata, Kariya-shi (JP); Yusuke Sugiyama, Kariya-shi (JP)

(73) Assignee: KABUSHIKI KAISHA TOYOTA JIDOSHOKKI, Kariya-shi, Aichi (JP)

(21) Appl. No.: 14/381,797

(22) PCT Filed: Nov. 21, 2012
(86) PCT No.: PCT/JP2012/007474

§ 371 Date: Aug. 28, 2014

(30) Foreign Application Priority Data
Mar. 2, 2012 (JP) 2012-046636

(51) Int. Cl. H01M 10/0569; H01M 4/13; H01M 4/48; H01M 4/62; H01M 10/0525

(52) U.S. Cl. CPC H01M 10/0569; H01M 4/622; H01M 10/0525; H01M 4/48; H01M 4/13; H01M 2004/027
USPC 429/338

(57) ABSTRACT

Providing a secondary battery maintaining the cyclability at room temperature and additionally being able to inhibit the cyclability from declining when being employed at high temperature.

A secondary battery includes a positive electrode including a positive-electrode active material, a negative-electrode including a negative-electrode active material, and an electrolytic solution, wherein the positive electrode and/or the negative electrode includes a binding agent containing an organic/inorganic hybrid material having an organic segment including a resin, and an inorganic segment including silica, the organic/inorganic hybrid material binding the positive-electrode active material and/or the negative-electrode active material, and the electrolytic solution includes a fluorine-containing cyclic carbonate containing at least one fluorine atom.

### TECHNICAL FIELD

The present invention relates to a secondary battery, such as lithium-ion secondary batteries.

### BACKGROUND ART

Since secondary batteries, such as lithium-ion secondary batteries, have a small size and exhibits a high capacity, respectively, the secondary batteries have been used in a wide variety of fields, like cellular phones and notebook-size computers. Moreover, in recent years, using the secondary batteries as a driving source for vehicle has been investigated.

A secondary battery has been comprising a positive electrode, a negative electrode, and an electrolytic solution. When the secondary battery is a lithium-ion secondary battery, the positive electrode, for example, comprises: a positive-electrode active material composed of a metallic composite oxide of lithium and a transition metal, such as a lithium-manganese composite oxide, a lithium-cobalt composite oxide or a lithium-nickel composite oxide, and so on; and a current collector covered with the positive-electrode active material. The negative electrode is formed by covering another current collector with a negative-electrode active material being able to sorb (or occlude) lithium ions therein and desorb (or release) them therefrom. As the negative-electrode active material being able to sorb lithium ions therein and desorb them therefrom, the following have been used: carbon materials, such as graphite and black lead, or silicon-based materials, such as silicon and silicon oxides, and so forth.

Incidentally, investigations have been made as to components within electrolytic solutions in order to upgrade battery characteristics. Patent Application Publication No. 1 discloses an electrolytic solution, to which a hydroxylic acid derivative compound has been added, for use in lithium-ion secondary battery. Moreover, as an employable organic solvent, Patent Application Publication No. 1 recites cyclic carbonates. Patent Application Publication No. 1 also recites that the high-temperature cyclability of a secondary battery upgrades when including, even among the cyclic carbonates, fluoroethylene carbonate (or FEC), difluoroethylene carbonate (or DFEC), vinylene carbonate (or VC), or vinylethylene carbonate (or VEC).

### RELATED ART

Patent Application Publication No. 1: WO2009/113545

### SUMMARY OF THE INVENTION

### Problems to be Solved by the Invention

As a common electrolytic solution, a nonaqueous electrolytic solution, in which LiPF₆ serving as an electrolyte is dissolved in an organic solvent having been prepared by mixing ethylene carbonate (or EC), ethyl methyl carbonate (or EMC) and dimethyl carbonate (or DMC) one another, has been available. As one of means for upgrading the cyclability of a secondary battery using this electrolytic solution, altering EC to FEC is given. FEC has a high oxidation-reduction potential, so that, even among the components of electrolytic solutions, FEC is a component that is likely to be reduced and then decomposed. Consequently, when carrying out charging and discharging operations with a secondary battery that uses an electrolytic solution including FEC, solid electrolyte interphase films (or SEI films) including reduced products of the FEC are likely to be formed. Because of the fact that the direct contacts between electrolytic solutions and active materials are prevented by means of the SEI films, so that degradations of the electrolytic solutions are inhibited, and thereby the cyclability of a battery is believed to upgrade.

However, according to investigations by the present inventors, the following had been understood: the cyclability of a secondary battery, which uses an electrolytic solution including FEC, declines under such a high-temperature environment as 55° C., when charging and discharging operations are carried out with the secondary battery, compared with a case where the charging and discharging operations are carried out therewith at room temperature. This phenomenon is presumed to result from the fact that the high-temperature stability of FEC is low, and from the other fact that the resulting SEI films dissolve in electrolytic solutions at high temperature, and so on.

The present invention is made in view of such circumstances. An object of the present invention is to provide a secondary battery, which not only maintains the cyclability at room temperature but also is able to inhibit the cyclability from declining when being employed at high temperature.

### Means for Achieving the Object

A secondary battery comprising a positive electrode including a positive-electrode active material, a negative-electrode including a negative-electrode active material, and an electrolytic solution, wherein

said positive electrode and/or said negative electrode includes a binding agent containing an organic/inorganic hybrid material having an organic segment comprising a resin, and an inorganic segment comprising silica, the organic/inorganic hybrid material binding said positive-electrode active material and/or said negative-electrode active material,

said electrolytic solution includes a fluorine-containing cyclic carbonate containing at least one fluorine atom.

Reasoning why the cyclability of the secondary battery according to the present invention is satisfactory is believed to be as follows.

As having been explained already, when the secondary battery according to the present invention is charged and discharged at room temperature, SEI films are formed on the surface of active materials by means of reducing and then decomposing the fluorine-containing cyclic carbonate, such as FEC. Since stabilized SEI films are formed under room temperature, good cyclability is maintained. On the other hand, when the secondary battery according to the present invention is charged and discharged at high temperature, hydrogen fluoride (HF) is likely to generate from the fluorine-containing cyclic carbonate, which is poor in terms of the high-temperature stability. Since HF has a property of corroding inorganic oxides, and the like, active materials and the HF make contact with each other so that fluorides are formed. Accordingly, there might possibly arise such a fear that the battery characteristics (especially, the cyclability) have declined. In the secondary battery according to the present invention, however, capturing HF onto the inorganic segment (i.e., silica) in the organic/inorganic silica hybrid material, which is included in the binding agent binding the active materials, is believed to lead to inhibiting the cyclability of the secondary battery from declining. Note that the silica in the organic/inorganic hybrid material does not adversely affect the battery characteristics even when the silica makes contact with HF to have been corroded, because the silica does not at all contribute to charging and discharging.

In particular, when the secondary battery according to the present invention comprises the negative electrode which uses the negative-electrode active material including a silicon oxide, the advantage of the present secondary battery becomes remarkable. This is because silicon oxides are likely to be corroded by HF. Moreover, since the inorganic segment (i.e., silica) in the organic/inorganic hybrid material is corroded by HF prior to the silicon oxide included in the negative-electrode active material, the cyclability is believed to be inhibited from declining.

### Advantages of the Invention

In accordance with the secondary battery according to the present invention, declining cyclability, which might possibly occur when a secondary battery employing an electrolytic solution including a fluorine-containing cyclic carbonate is employed at high temperature, is inhibited from arising.

### BRIEF DESCRIPTION OF THE DRAWINGS

FIG. 1 is a graph showing results when a secondary battery according to the present invention, as well as secondary batteries according to a comparative example and reference example were caused to charge and discharge at 25° C., and illustrates changes in the discharge-capacity maintenance rate versus increments in the number of cycles; and

FIG. 2 is a graph showing results when the secondary battery according to the present invention, as well as the secondary batteries according to the comparative example and reference example were caused to charge and discharge at 55° C., and illustrates changes in the discharge-capacity maintenance rate versus increments in the number of cycles.

### DETAILED DESCRIPTION OF THE PREFERRED EMBODIMENTS

The following describes some of modes for performing a secondary battery according to the present invention. Note that, unless otherwise specified, ranges of numeric values, namely, “from ‘a’ to ‘b’” set forth in the present description, involve the lower limit, “a,” and the upper limit, “b,” in the ranges. And, the other ranges of numeric values are composable by combining any of the two, which involve not only these upper-limit values and lower-limit values but also numeric values enumerated in embodiments specified below.

A secondary battery according to the present invention comprises a positive-electrode including a positive-electrode active material, a negative electrode including a negative-electrode active material, and an electrolytic solution, primarily. The following describes the positive electrode, the negative electrode, the electrolytic solution, and the other constructions.

### Positive Electrode

An allowable positive electrode includes a positive-electrode active material being capable of sorbing and desorbing alkali-metal ions, such as lithium ions or sodium ions making electrolyte ions, and a binding agent binding the positive-electrode active material. In addition, a permissible positive electrode also includes a conductive additive. The positive-electrode active material, binding agent and conductive additive are not limited especially at all, so that positive-electrode active materials, binding agents and conductive additives, which have been available for secondary batteries, are employable.

The binding agent is detailed later. A preferable blending proportion of the binding agent is (Positive-electrode Active Material):(Binding Agent)=from 1:0.05 to 1:0.2 by mass ratio. When the blending proportion of the binding agent falls in this range, the energy density of an electrode is upgraded without declining the formability of the electrode.

When the positive-electrode includes a conductive additive, materials, which have been used commonly in electrodes for secondary battery as the conducive additive, are usable. As a conductive additive, one of the following conductive carbon materials is used preferably: carbon fibers, carbon blacks (i.e., carbonaceous fine particles), such as acetylene black or KETJENBLACK, for instance. Other than the conductive carbon material, using a well-known conductive additive, such as conductive organic compounds, is permissible as well. Using one member of the conductive additives independently, or mixing two or more members of the conductive additives one another to use, is acceptable. A preferable blending proportion of the conductive additive is (Positive-electrode Active Material):(Conductive Additive)=from 1:0.01 to 1:0.3 by mass ratio. When the blending proportion of the conductive additive falls in this range, not only conductive passes with better efficiency are formed, but also the energy density of an electrode is upgraded without declining the formability of the electrode.

As for a positive-electrode active material, the following are applicable, for instance: metallic composite oxides of transition metals and elements making electrolyte ions, such as lithium-manganese composite oxides, lithium-cobalt composite oxides and lithium-nickel composite oxides. To be concrete, when the positive-electrode active material is a positive-electrode active material for lithium or lithium-ion secondary battery, the following are given as the positive-electrode active material: LiCoO₂, LiNi_{1/3}Co_{1/3}Mn_{1/3}O₂, Li₂MnO₃, and so on. As the positive-electrode active material, the following are also applicable, for instance: active materials which do not include any element like lithium making electrolyte ions in charging and discharging, such as sulfur elementary substance (S) and sulfur-modified compounds in which sulfur has been introduced into organic compounds like polyacrylonitrile. When both of the positive electrode and negative electrode employ active materials which do not include any element making electrolyte ions, pre-doping the positive electrode and/or the negative electrode with an element making electrolyte ions is necessary. A preferable positive-electrode active material has a powdery shape, but particle diameters of the positive-electrode active material are not at all limited especially.

An employable current collector for the positive electrode are current collectors having been used employed commonly for positive electrodes for secondary battery, such as aluminum, nickel and stainless steels. Current collectors with various configurations, such as meshes and metallic foils, are applicable.

The above-mentioned positive-electrode active material constitutes a positive-electrode material covering the current collector on the surface at least. In general, the positive electrode is formed by press attaching the aforementioned positive-electrode material onto the current collector as a positive-electrode active-material layer.

### Negative Electrode

An allowable negative electrode includes a negative-electrode active material being capable of sorbing and desorbing alkali-metal ions, such as lithium ions or sodium ions making electrolyte ions, and a binding agent binding the negative-electrode active material. In addition, a permissible negative electrode also includes a conductive additive.

The binding agent is detailed later. A blending proportion of the binding agent is (Negative-electrode Active Material):(Binding Agent)=from 1:0.05 to 1:0.2 by mass ratio. When the blending proportion of the binding agent falls in this range, the energy density of an electrode is upgraded without declining the formability of the electrode.

When the negative-electrode includes a conductive additive, materials, which have been used commonly in electrodes for secondary battery as the conducive additive, are usable. For example, one of the following conductive carbon materials is used preferably: carbon fibers, carbon blacks (i.e., carbonaceous fine particles), such as acetylene black or KETJENBLACK. Other than the conductive carbon material, using a well-known conductive additive, such as conductive organic compounds, is permissible as well. As the conductive additive, using one member of the conductive additives independently, or mixing two or more members of the conductive additives one another to use, is acceptable. A preferable blending proportion of the conductive additive is (Negative-electrode Active Material):(Conductive Additive)=from 1:0.01 to 1:0.3 by mass ratio. When the blending proportion of the conductive additive falls in this range, not only conductive passes with better efficiency are formed, but also the energy density of an electrode is upgraded without declining the formability of the electrode.

When the secondary battery according to the present invention is a lithium-ion secondary battery, an allowable negative-electrode active material comprises an element being capable of sorbing and desorbing lithium ions and being capable of alloying with lithium, and/or a compound including an element being capable of alloying with lithium. As for an element being capable of alloying with lithium, the following can be given, for instance: Na, K, Rb, Cs, Fr, Be, Mg, Ca, Sr, Ba, Ra, Ti, Ag, Zn, Cd, Al, Ga, In, Si, Ge, Sn, Pb, Sb, and Bi. Employing the negative-electrode active material including one or more members of the elements is preferable. Even among the elements, a proper element, which is capable of alloying with lithium, is silicon (Si) or tin (Sn). A proper compound including an element, which is capable of alloying with lithium, is silicon compounds, or tin compounds. A proper silicon compound is silicon compounds expressed by SiOₓ (where 0.3≦“x”≦2.3). As for a tin compound, the following are given, for instance: tin alloys, such as Cu—Sn alloys or Co—Sn alloys. Moreover, as the negative-electrode active material, carbon-based materials, such as graphite, are also employable, or metallic lithium is employable as well. As the negative-electrode active material, employing one member of the above options independently, or mixing two or more members thereof one another, is acceptable.

The above-mentioned SiOₓ preferably includes an Si phase, and an SiO₂ phase. The Si phase is a phase comprising a silicon elementary substance, and being able to sorb and desorb electrolytic ions. The Si phase has a large theoretical discharge capacity, and expands and contracts as being accompanied by sorbing and desorbing electrolytic ions. The SiO₂ phase comprises SiO₂, and relieves expansions and contractions of the Si phase. An allowable negative-electrode active material comprising an Si phase and SiO₂ phase is formed by covering the Si phase with the SiO₂ phase. In addition, a plurality of the Si phases, which have been miniaturized, is covered with the SiO₂ phase so that the Si phase and SiO₂ phase preferably become integral or a single particle, namely, a permissible negative-electrode active material. In the above case, volumetric changes in the entire negative-electrode active-material particles are kept down effectively.

A preferable mass ratio of the SiO₂ phase to the Si phase in the negative-electrode active material is from 1 to 3. When the mass ratio is 1 or more, expansions and contractions of the negative-electrode active material are inhibited. When the mass ratio is 3 or less, the charge and discharge capacities are kept high in the negative-electrode active material.

As a raw material for the negative-electrode active material, using a raw-material powder including silicon monoxide is allowable. In this instance, silicon monoxide within the raw-material powder undergoes disproportionation into two phases, an SiO₂ phase and an Si phase. In the disproportionation of silicon monoxide, silicon monoxide, a homogeneous solid in which an atomic ratio between Si and O is 1:1 roughly, undergoes separation into two phases, an SiO₂ phase and an Si phase, by reactions inside the solid. A silicon-oxide powder obtained by the disproportionation includes an SiO₂ phase, and an Si phase.

The disproportionation of silicon monoxide in a raw-material powder proceeds by giving energy to the raw-material powder. As a disproportionation method for silicon monoxide, such a method as heating the raw-material powder, milling it, and so on, are given.

When the raw-material powder is heated, almost all of silicon monoxide are said in general to disproportionate to separate into the two phases at 800° C. or more under such circumstances where oxygen is cut off. To be concrete, a silicon-oxide powder, which includes two phases with a non-crystalline SiO₂ phase and a crystalline Si phase, is obtainable by means of carrying out a heat treatment with respect to a raw-material powder including a non-crystalline silicon-monoxide powder at from 800° C. to 1, 200° C. within an inert atmosphere, such as within a vacuum or within an inert gas, for from 1 hour to 5 hours.

When the raw-material is subjected to milling, some of mechanical energy in milling contributes to chemical atomic diffusions at the solid-phase interface of the raw-material powder, thereby generating the oxide phase, the silicon phase, and so on. Upon milling, the raw-material powder is mixed allowably by employing a type-V mixer, a ball mill, an attritor, a jet mill, a vibrational mill or a high-energy ball mill, and the like, under an inert-gas atmosphere, such as within a vacuum or within an argon gas. After milling the raw-material powder, further subjecting the milled raw-material powder to a heat treatment is also permissible, in order to facilitate the disproportionation of silicon monoxide.

A preferable negative-electrode active material has a powdery shape. An allowable average particle diameter is from 1 μm to 10 μm. A permissible negative-electrode active-material powder is classified to 2 μm or less, or furthermore to 4 μm or less, to employ.

The above-mentioned negative-electrode active material constitutes a negative-electrode material covering the current collector on the surface at least. In general, the negative electrode is formed by press attaching the aforementioned negative-electrode material on to the current collector as a negative-electrode active-material layer. In a proper current collector, one of the following is used: meshes or foils made of metals, such as copper and copper alloys.

### Binding Agent

The secondary battery according to the present invention includes a binding agent in the positive electrode, and/or in the negative electrode. The binding agent binds the positive-electrode active material in the positive electrode, and binds the negative-electrode active material in the negative electrode, respectively. The binding agent contains an organic/inorganic hybrid material. The organic/inorganic hybrid material primarily has an organic segment in which a resin, such as organic polymers, makes the major component, and an in organic segment in which silica makes the major component. The following describes the organic/inorganic hybrid material.

A preferable organic/inorganic hybrid material is a cured substance of an alkoxysilyl group-containing compound containing an alkoxysilyl group. The alkoxysilyl group has a structure specified by formula (I).

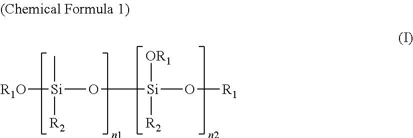

In Formula (I), “R₁,” “R₂,” “n₁,” and “n₂” respectively stand for the following independently: “R₁”: an alkyl group whose number of carbon atoms is from 1 to 8; “R₂”: an alkyl group or alkoxyl group whose number of carbon atoms is from 1 to 8; and “n₁” and “n₂”: an integer of from 1 to 100. In an especially preferable alkoxysilyl group, all of “R₁” and “R₂” are a methyl group, respectively. That is, the alkoxysilyl group-containing compound is a compound in which a component (i.e., alkoxysilyl group) expressed by formula (I) and changing into silica has been bonded to at least some of precursors of various resins making a base.

The precursors of resins making a base are not at all limited especially in types, as far as the precursors are precursors complying with a structure of the organic segment in the organic/inorganic hybrid material. To be concrete, the following precursors are given: precursors of bisphenol type-A epoxy resins, precursors of novolac-type epoxy resins, precursors of acrylic resins, precursors of phenolic resins, polyamic acid (i.e., precursors of polyimide resins), precursors of soluble polyimide resins, precursors of polyurethane resins, and precursors of polyamide-imide resins. That is, as an alkoxysilyl group-containing compound in which an alkoxysilyl group expressed by formula (I) has been introduced into the precursors of the above resins, the following can be given specifically: alkoxy group-containing silane-modified bisphenol type-A epoxy resins, alkoxy group-containing silane-modified novolac-type epoxy resins, alkoxy group-containing silane-modified acrylic resins, alkoxy group-containing silane-modified phenolic resins, alkoxy group-containing silane-modified polyamic acid resins, alkoxy group-containing silane-modified soluble polyimide resins, alkoxy group-containing silane-modified polyurethane resins, and alkoxy group-containing silane-modified polyamide-imide resins. A desirable binding agent is made from one or more members selected from the above groups as a raw material.

The alkoxysilyl group-containing compounds are synthesized by publicly-known techniques, respectively. For example, when the alkoxysilyl group-containing compound is an alkoxy group-containing silane-modified polyamic acid resin, the alkoxysilyl group-containing compound is synthesized by reacting a polyamic acid comprising a carboxylic-acid-anhydride component and a diamine component, with an alkoxysilane partial condensate. As for the alkoxysilane partial condensate, a usable partial condensate is obtainable by partially condensing hydrolysable alkoxysilane monomers in the presence of acid or base catalyst as well as water. On this occasion, the alkoxy group-containing silane-modified polyamic acid resin is also formed as follows: the alkoxysilane partial condensate is reacted with an epoxy compound in advance to turn the reactants into an epoxy group-containing alkoxysilane partial condensate; and then the resulting epoxy group-containing alkoxysilane partial condensate is reacted with the polyamic acid.

The organic/inorganic hybrid material having an organic segment and an inorganic segment is obtainable by curing an alkoxysilyl group-containing compound. To be concrete, an alkoxysilyl group expressed by formula (I) contributes to a sol-gel reaction, and thereby the inorganic segment comprising silica is synthesized. A sol-gel process is explained below. For a starting raw material for the sol-gel process, metallic alkoxides (i.e., compounds expressed by M(OR)_{y} where “M” is a metal, “OR” is an alkoxysilyl group, and “y” is an integer in compliance with a valence of the “M”) are used. The compounds expressed by M(OR)_{y} react as set forth in equation (A) by hydrolysis.

M(OR)_{y}+H₂O--->M(OH)(OR)_{y-1}+ROH Equation (A)

M(OH)_{y} is generated eventually when the reaction shown herein is facilitated furthermore, and then reacts as set forth in following equation (B) when condensation occurs between two hydroxide molecules generated herein.

M(OH)_{y}+M(OH)_{y}--->(OH)_{y-1}M-O-M(OH)_{y-1}+H₂O Equation (B)

On this occasion, all the OH groups are capable of undergoing polycondensation. Moreover the OH groups are capable of undergoing dehydration/condensation polymerization reaction with organic polymers having an OH group at the terminal ends as well.

That is, in an alkoxysilyl group-containing compound, the alkoxysilyl group expressed by formula (I) turns into silica, and simultaneously therewith the alkoxysilyl group-containing compound reacts with another alkoxysilyl group-containing compound's alkoxysilyl group as well. Alternatively, an alkoxysilyl group expressed by formula (I) turns into silica, and simultaneously therewith the alkoxysilyl group-containing compound reacts with an OH group, and the like, with which an organic segments (or resinous precursor) is provided, to bond to the OH group. In other words, after curing an alkoxysilyl group-containing compound, an organic/inorganic hybrid material, which desirably has a structure in which an organic segment composed of resin is cross-linked with an inorganic segment composed of silica, is obtainable. Consequently, the resulting organic/inorganic hybrid material has good adhesiveness to current collectors, active materials and conductive additives that are not organic, so that the active materials, and so on, are retained firmly onto the current collectors.

The curing process until an organic segment is formed depends on types of resins constituting the organic segment. Usually, an alkoxysilyl group-containing compound is mixed with a positive-electrode active material or a negative-electrode active material, if needed, along with a conductive additive and a solvent. For an organic segment, the following are given: organic segments solidifying (or drying) as they are by simply evaporating the solvents, and organic segments solidifying by means of various polymerization reactions after volatilizing the solvents. For example, when a resin constituting an organic segment is a thermosetting resin, the resin causes condensation polymerization by heating so that polymeric networked structures are formed.

Proper curing conditions are selected in compliance with types of alkoxysilyl group-containing compounds to be employed. However, curing the alkoxysilyl group-containing compounds by heating is not only simple and easy, but also is desirable. Heating changes an organic segment in a resin precursor into an organic segment composed of a resin from which the solvent has been volatilized to solidify the resin precursor, and heating also changes an alkoxysilyl group expressed by formula (I) in the resin precursor into an inorganic segment by facilitating the hydrolysis and condensation polymerization of the alkoxysilyl group. Thus, an organic/inorganic hybrid material, which has the organic segment composed of the resin and the inorganic segment composed of silica, is obtainable.

That is, the specific examples of alkoxysilyl group-containing compounds having been already enumerated are respectively turned into the following by curing: bisphenol type-A epoxy resin-silica hybrids, novolac-type epoxy resin-silica hybrids, acrylic resin-silica hybrids, phenolic resin-silica hybrids, polyimide resin-silica hybrids, soluble polyimide resin-silica hybrids, polyurethane resin-silica hybrids, and polyamide-imide resin-silica hybrids. As for the binding agent, an applicable binding agent indispensably includes at least one or more members of the resin-silica hybrids.

The inorganic segment of the organic/inorganic hybrid material is very fine. When “n” is from 1 to 100 in formula (I), sizes of silica particles are on the order of a few nanometers. Therefore, silica is dispersed finely in the organic/inorganic hybrid material.

When the organic/inorganic hybrid material is any of the above-mentioned organic/inorganic hybrid materials, desirable heating conditions are at from 80° C. to 250° C. and for from 2 hours to 4 hours approximately, although the heating conditions depend on a layer's thickness formed on a current collector. However, the heating conditions are not at all restricted to the above conditions.

An allowable organic/inorganic hybrid material is included in at least one of the positive electrode and negative electrode as a binding agent. A preferable organic/inorganic hybrid material is included in a binding agent for binding a negative-electrode active material including a silicon oxide, from the viewpoint of reducing an adverse influence of HF against the silicon oxide used as the negative-electrode active material. In particular, when the negative-electrode active material comprises a silicon-based negative-electrode active material including Si, alkoxysilyl groups of an alkoxysilyl group-containing compound bond preferentially to the surface of the silicon-based negative-electrode active material including Si, so that a stable film is formed on the surface of the silicon-based negative-electrode active material. This is believed to result from the fact that alkoxy groups are likely to react with superficial hydroxyl groups (i.e., —OH groups) in the silicon-based negative-electrode active material. However, since composite oxides used as a positive-electrode active material are also susceptible to the influence of HF, using an organic/inorganic hybrid material also as a biding agent for binding the positive-electrode active material is effective.

Moreover, an allowable binding agent not only includes an organic/inorganic hybrid material indispensably, but also includes another binding agent as well. When the entirety of a preferable binder agent is taken as 100% by mass, an organic/inorganic hybrid material is included in an amount of 30% by mass or more, or furthermore in an amount of from 50% by mass to 100% by mass. As for the other binder component, the following are exemplified, for instance: polyvinylidene fluoride (e.g., polyvinylidene difluoride (or PVDF)), polytetrafluoroethylene (or PTFE), styrene-butadiene rubber (or SBR), polyimide (or PI), polyamide-imide (or PAI), carboxymethylcellulose (or CMC), polyvinylchloride (or PVC), metacrylate resin (or PMA), polyacrylonitrile (or PAN), modified polyphenylene oxide (or PPO), polyethylene oxide (or PEO), polyethylene (or PE), or polypropylene (or PP). Note that, in a permissible binding agent, one or more members of the other binding components are combined with an organic/inorganic hybrid material to use.

Note that, as an alkoxysilyl group-containing compound, commercial products are used suitably. For example, a variety commercial products are available as follows: “COMPOCERAN E (product name)” (produced by ARAKAWA CHEMICAL INDUSTRIES, LTD.), one of alkoxy group-containing silane-modified bisphenol type-A epoxy resins or alkoxy group-containing silane-modified novolac-type epoxy resins; “COMPOCERAN AC (product name)” (produced by ARAKAWA CHEMICAL INDUSTRIES, LTD.), one of alkoxy group-containing silane-modified acrylic resins; “COMPOCERAN P (product name)” (produced by ARAKAWA CHEMICAL INDUSTRIES, LTD.), one of alkoxy group-containing silane-modified phenolic resins; “COMPOCERAN H800 (product name)” (produced by ARAKAWA CHEMICAL INDUSTRIES, LTD.), one of alkoxy group-containing silane-modified polyamic resins; “COMPOCERAN H700 (product name)” (produced by ARAKAWA CHEMICAL INDUSTRIES, LTD.), one of alkoxy group-containing silane-modified soluble polyimide resins; “UREANO U (product name)” (produced by ARAKAWA CHEMICAL INDUSTRIES, LTD.), one of alkoxy group-containing silane-modified polyurethane resins; or “COMPOCERAN H900 (product name)” (produced by ARAKAWA CHEMICAL INDUSTRIES, LTD.), one of alkoxy group-containing silane-modified polyamide-imide resins.

A bisphenol type-A epoxy resin-silica hybrid, or a novolac-type epoxy resin-silica hybrid is obtainable by curing “COMPOCERAN E.” An acrylic resin-silica hybrid is obtainable by curing “COMPOCERAN AC.” A phenolic resin-silica hybrid is obtainable by curing “COMPOCERAN P.” A polyimide resin-silica hybrid is obtainable by curing “COMPOCERAN H800.” A soluble polyimide resin-silica hybrid is obtainable by curing “COMPOCERAN H700.” A polyurethane resin-silica is obtainable by curing “UREANO U.” A polyamide-imide resin-silica hybrid is obtainable by curing “COMPOCERAN H900.”

### Electrolytic Solution

The electrolytic solution includes a fluorine-containing cyclic carbonate containing at least one fluorine atom. The electrolytic solution is a nonaqueous electrolytic solution in which an alkali-metal salt serving as an electrolyte has been dissolved in an organic solvent, and includes the fluorine-containing cyclic carbonate indispensably in the secondary battery according to the present invention. An allowable fluorine-containing cyclic carbonate includes at least one fluorine atom, and including another halogen atom is permissible, too. However, a preferable fluorine-containing cyclic carbonate is expressed by following formula (II).

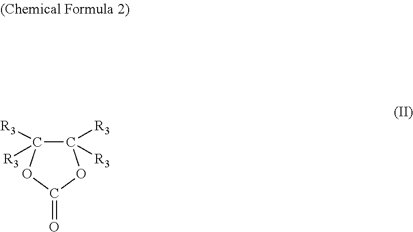

(In formula (II), each of the “R₃” groups is hydrogen, fluorine, an alkyl group or an fluorinated alkyl group independently, and at least one of the “R₃” groups stands for fluorine or a fluorinated alkyl group.)

An allowable electrolytic solution includes one or more members of fluorine-containing cyclic carbonates expressed by formula (II). When the “R₃” groups are an alkyl group or fluorinated alkyl group in formula (II), respectively, a preferable number of carbon atoms is 1 or in the alkyl group or fluorinated alkyl group. In particular, a preferable electrolytic solution includes a fluorine-containing cyclic carbonate having such structure as expressed by following formulas (II-1) through (II-3) in which at least one fluorine atom has bonded to one or more carbon atoms constructing the cyclic structure.

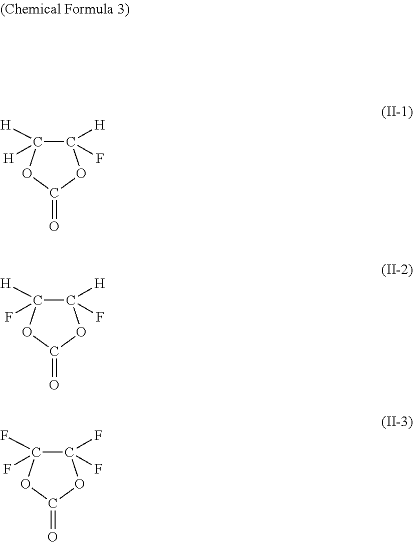 [SMILES: O=C1OCC(F)O1 ; O=C1OC(F)C(F)O1 ; O=C1OC(F)(F)C(F)(F)O1]

Even among the above fluorine-containing cyclic carbonates, 4-fluoro-1,3-dioxolan-2-one (i.e., fluoroethylene carbonate (or FEC)) expressed by formula (II-1) is preferable.

As the electrolytic solution, another organic solvent is employable along with the fluorine-containing cyclic carbonate. As for another organic solvent, an aprotic organic solvent is allowable. For example, using cyclic carbonates (except for fluorine-containing cyclic carbonates), linear carbonates, or ethers, and so on, is permissible. In particular, using a cyclic carbonate including a fluorine-containing cyclic carbonate and a linear carbonate combinedly is preferable. A cyclic carbonate exhibits a high permittivity, but a linear carbonate exhibits a low viscosity. Consequently, electrolyte ions are not prevented from moving by making an electrolytic solution include both cyclic carbonate and linear carbonate, so that battery capacity upgrades.

When the entirety of an organic solvent in the electrolytic solution is taken as 100% by volume, a cyclic carbonate allowably accounts for from 20% by volume to 40% by volume, or furthermore from 25% by volume to 35% by volume; and a linear carbonate permissibly accounts for from 60% by volume to 80% by volume, or furthermore from 65% by volume to 75% by volume. Whereas a cyclic carbonate enhances a permittivity of the electrolytic solution, the cyclic carbonate's viscosity is high. When the permittivity rises, a conductivity of the electrolytic solution becomes better. When the viscosity is high, electrolyte ions are prevented from moving so that the conductivity becomes worse. Although a linear carbonate has a low permittivity, the linear carbonate's viscosity is low. Compounding both of the cyclic carbonate and linear carbonate within the above-mentioned compounding ratio in a well-balanced manner leads to preparing a solvent with good conductivity while heightening an organic solvent' permittivity to a certain extent, and moreover while even lowering the viscosity, so that battery capacity upgrades.

When the entirety of an organic solvent in the electrolytic solution is taken as 100% by volume, a fluorine-containing cyclic carbonate preferably accounts for from 1% by volume to 40% by volume, or furthermore from 25% by volume to 35% by volume. In the above case, since the electrolytic solution's viscosity is kept low so that electrolyte ions are made likely to move, not only a battery is upgraded in charging/discharging cyclability, but also the battery is upgraded more in battery capacity.

The cyclic carbonate comprises a fluorine-containing cyclic carbonate serving as an indispensable component. In addition to the fluorine-containing cyclic carbonate, a proper cyclic carbonate further includes one or more members selected from the group consisting of propylene carbonate (or PC), ethylene carbonate (or EC), butylene carbonate, γ-butyrolactone, vinylene carbonate, 2-methyl-gamma-butyrolactone, acetyl-gamma-butyrolactone, and gamma-valerolactone.

As far as a linear carbonate has a chain shape, the linear carbonate is not limited at all especially. For example, one or more members, which are selected from the following, are applicable: dimethyl carbonate (or DMC), diethyl carbonate (or DEC), ethyl methyl carbonate (or EMC), dibutyl carbonate, dipropyl carbonate, alkyl propionate ester, dialkyl malonate ester, and alkyl acetate ester.

Moreover, as ethers, the following are given, for instance: tetrahydrofuran, 2-methyltetrahydrofuran, 1,4-dioxane, 1,2-dimethoxyethane, 1,2-diethoxyethane, and 1,2-dibutoxyethane.

A preferable electrolyte is an alkali-metal fluoride salt being soluble in organic solvents. An applicable alkali-metal fluoride salt is preferably at least one member selected from the group consisting of LiPF₆, LiBF₄, LiASF₆, NaPF₄, NaBF₄ and NaAsF₆. A proper concentration of the electrolyte is from 0.5 mol/L to 1.7 mol/L approximately.

### Other Constituents

The secondary battery according to the present invention comprises the above-mentioned positive electrode and negative electrode, and the above-mentioned electrolytic solution. This secondary battery further comprises a separator interposed between the positive electrode and the negative electrode in the same manner as common secondary batteries. The separator is disposed between the positive electrode and the negative electrode, thereby not only permitting movements of ions between the positive electrode and the negative electrode but also preventing the positive electrode and negative electrode from short-circuiting internally. When a nonaqueous-electrolyte secondary battery is an enclosed type, the separator is required to have a function of retaining electrolytic solutions therein. As for the separator, using thin-walled and microporous or non-woven fabric-like membranes, which are made of polyethylene, polypropylene, PAN, aramid, polyimide, cellulose, or glass, and so on, is preferable.

There are not any restrictions at all especially as to a configuration of the secondary battery, so that various sorts of configurations, such as cylindrical types, laminated types and coin types, are employable. Even when any one of the configurations is adopted, the separators are interposed between the positive electrodes and the negative electrodes to make electrode assemblies. Then, after connecting intervals from the positive-electrode current collectors and negative-electrode current collectors up to the respective positive-electrode terminals and negative-electrode terminals, which lead to the outside, with leads for collecting electricity, the electrode assemblies are sealed hermetically in a battery case along with the electrolytic solution, thereby turning the constituent members into a battery.

An allowable vehicle has the secondary battery according to the present invention on-board. A permissible vehicle is vehicles making use of electric energies produced by the secondary battery for all or some of the power source, so electric vehicles, hybrid vehicles, and so on, are available, for instance. When a vehicle has the secondary battery on-board, the secondary battery is connected preferably in a quantity of multiple pieces in series to make an assembled battery. Other than the vehicles, the secondary battery is likewise applicable to all sorts of products given as follows: household electrical appliances, office instruments or industrial instruments, which are driven with batteries, such as personal computers or portable communication devices, and so forth.

So far, the modes for embodying the secondary battery according to the present invention have been explained. However, the present invention is not an invention which is limited to the aforementioned embodying modes. The present invention is executable in various modes, to which changes or modifications that one of ordinary skill in the art carries out are made, within a range not departing from the gist of the present invention.

### Embodiment

The present invention is hereinafter described concretely, while giving an embodiment of the secondary battery according to the present invention.

### Lithium-Ion Secondary Battery According to Embodiment

A secondary battery was manufactured following procedures described below. The secondary battery included a polyamide-imide/silica hybrid binder in the negative electrode, and a fluoroethylene carbonate (or FEC) in the electrolytic solution.

The following were readied as a negative-electrode active material, and a conductive additive, respectively: a mixed powder of a silicon oxide powder disproportionated by a heat treatment (SiOₓ (where “x” was from 0.3 to 1.6) with 5 μm average diameter, a product of SIGMA-ALDRICH Co., Ltd.), and a massive artificial graphite (or MAG with 20 μm or less particle diameters); and KETJENBLACK (or KB). Moreover, as a raw material for making a binding agent binding the above negative-electrode active material and conductive additive, a silane-modified polyamide-imide resin (“COMPOCERAN H900” produced by ARAKAWA CHEMICAL INDUSTRIES, LTD.) was readied. The basic skeleton of “COMPOCERAN H900” is specified below.

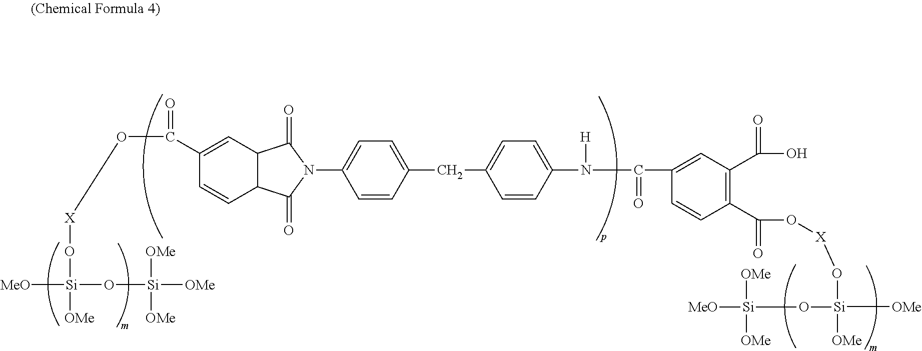

where “Me” is a methyl group, “X” is a spacer of an alkyl group, and “m” is from 0 to 2.

The above-mentioned negative-electrode active material, conductive additive and binding agent were mixed one another, and thereby a slurry-like mixture was obtained. Note that, in this mixture, N-methyl-2-pyrolidone (or MNP) serving as a solvent for “COMPOCERAN H900” was included. A mass ratio between the SiOₓ, MAG, KB and silane-modified polyamide-imide resin, from which the solvent was excluded, was set at such a ratio as SiOₓ/MAG/KB/Silane-modified Polyamide-imide Resin=42/40/3/15.

Next, the slurry-like mixture was coated onto one of the opposite faces of a 20 μm-thickness copper foil, which served as a current collector, with use of a doctor blade, was then pressed by a predetermined pressure, and was thereafter heated at 200° C. for 2 hours to cure the binding agent. Thus, a negative electrode, which comprised the current collector provided with a 15 μm-thickness negative-electrode active-material layer on the surface, was obtained. Here, the polyamide-imide resin making a base constructed organic segments, whereas the silane-modified parts at the terminal ends of the polyamide-imide resin underwent hydrolysis and condensation polymerization by water within the atmosphere so that the silane-modified parts changed into silica, thereby constructing inorganic segments. On this occasion, since the silane-modified parts reacted with and then bonded to the silane-modified parts at the terminal ends of another polyamide-imide resin, the silane-modified polyamide-imide resin changed into a polyamide-imide resin/silica hybrid in which the polyamide-imide resins serving as the organic segments are cross linked by silica serving as the inorganic segments.

Next, the following were readied as a positive-electrode active material, a conductive additive, and a binding agent, respectively: a lithium composite oxide LiNi_{1/3}Co_{1/3}Mn_{1/3}O₂); acetylene black (AB); and polyvinylidene fluoride (PVDF). These components were mixed one another in such amass ratio as Lithium Composite Oxide/AB/PVDF=88/6/6, and were then turned into a slurry-like mixture. This slurry-like mixture was coated onto one of the opposite faces of a 20 μm-thickness aluminum foil, which served as a current collector, was then pressed to be formed, and was thereafter heated at 120° C. for 6 hours. Thus, a positive electrode, which comprised the current collector provided with a 50 μm-thickness positive-electrode active-material layer on the surface, was obtained.

Using the positive electrode and negative electrode that had been manufactured following the above-mentioned procedures, a lithium-ion secondary battery was manufactured. An electrode assembly was manufactured by holding a polypropylene porous membrane serving as a separator in place between the positive electrode and the negative electrode whose positive-electrode active-material layer and negative-electrode active-material layer were disposed face-to-face. This electrode assembly was sealed with aluminum films, along with an electrolytic solution, and was thereby turned into a laminated cell. Upon the sealing, two pieces of aluminum films were made into a bag-shaped pouch by doing heat welding to the aluminum films at the circumference except for one of the sides, and an opening of the bag-shaped pouch was sealed completely air tightly, while doing vacuum suctioning, after putting the electrode assembly and further the electrolytic solution into the bag-shaped pouch through the opening. On this occasion, the positive-electrode-side and negative-electrode-side leading ends of the current collectors were protruded from the marginal ends of the films, thereby making the leading ends connectable to external terminals.

The used electrolytic solution was as follows: LiPF₆ was dissolved as an electrolyte so as to make 1 mol/L in an organic solvent that had been prepared by mixing fluoroethylene carbonate (or FEC), ethyl methyl carbonate (or EMC) and dimethyl carbonate (DMC) one another in such a volumetric ratio as FEC/EMC/DMC=3/3/4.

### Lithium-Ion Secondary Battery According to Comparative Example

Except for altering the silane-modified polyamide-imide resin (or hybridized binder) employed in the lithium-ion secondary battery according to Embodiment to a polyamide-imide resin (or un-hybridized binder), a lithium-ion secondary battery according to Comparative Example was manufactured following the same procedures as set forth above. The employed polyamide-imide resin is specified below.

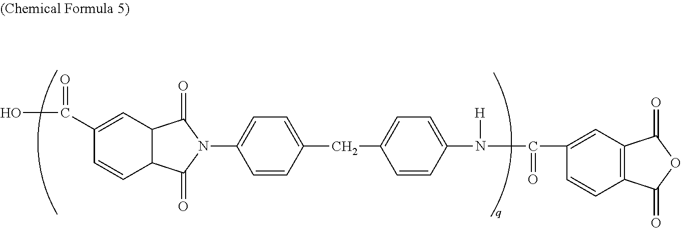

where “q” is from 1 to 100 approximately on average.

### Lithium-Ion Secondary Battery According to Reference Example

Except for altering the FEC-containing electrolytic solution used in the lithium-ion secondary battery according to Embodiment to an FEC-free electrolytic solution, a lithium-ion secondary battery according to Reference Example was manufactured following the same procedures as set forth above.

In the electrolytic solution of the lithium-ion secondary battery according to Reference Example, LiPF₆ was dissolved as an electrolyte so as to make 1 mol/L in an organic solvent that had been prepared by mixing ethylene carbonate (or EC), ethyl methyl carbonate (or EMC) and dimethyl carbonate (DMC) one another in such a volumetric ratio as EC/EMC/DMC=3/3/4.

The lithium-ion secondary batteries according to Embodiment, Comparative Example and Reference Example used the binders, the electrolytic solutions, and the organic solvents included in the electrolytic solutions, as shown in Table 1.

TABLE 1

| | Binder | | Electrolytic |
|---|---|---|---|
| | | | Solution |
| | Positive | | (Volumetric |
| | Electrode | Negative Electrode | Ratio) |
| Embodiment | PVDF | Polyamide-imide/ | FEC/EMC/DMC = |
| | | Silica Hybrid | 3/3/4 |
| Comparative | PVDF | Polyamide-imide Resin | FEC/EMC/DMC = |
| Example | | (Un-hybridized) | 3/3/4 |
| Reference | PVDF | Polyamide-imide/ | EC/EMC/DMC = |
| Example | | Silica Hybrid | 3/3/4 |

### Charging/Discharging Test

For the lithium-ion secondary batteries according to Embodiment, Comparative Example and Reference Example manufactured following the above-mentioned procedures, a charging/discharging test was carried out under a room-temperature condition (or at 25° C.), and under a high-temperature condition (or at 55° C.).

Prior to the charging/discharging test, a conditioning treatment was carried out to the respective lithium-ion secondary batteries. The conditioning treatment was carried out by charging and discharging the lithium-ion secondary batteries three times repeatedly at 25° C.

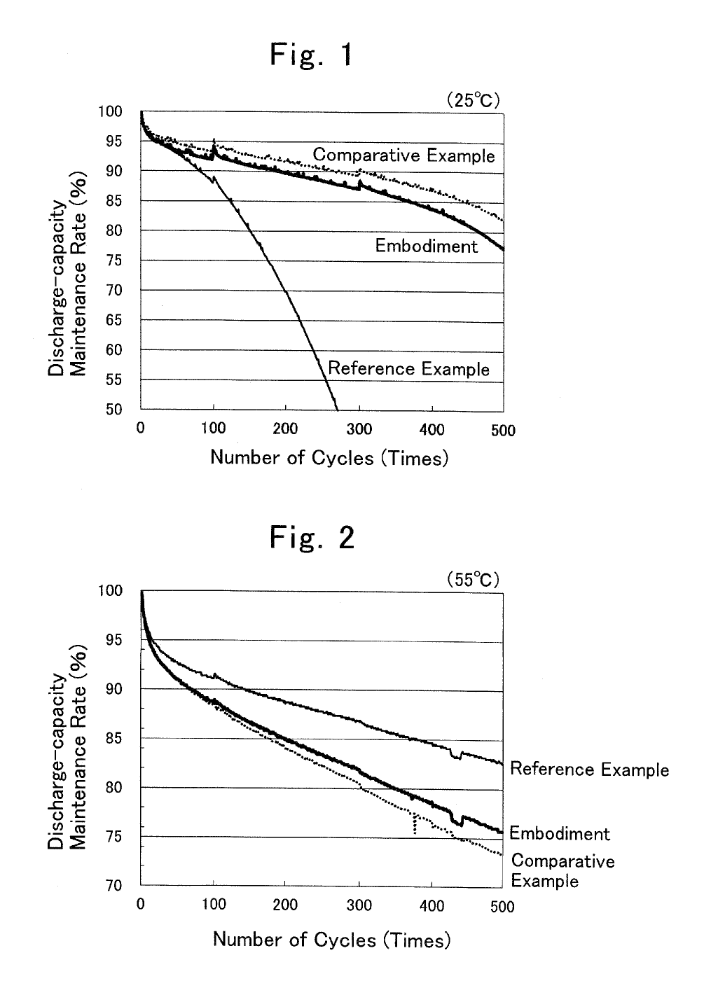

In the charging/discharging test, a charging condition was set to establish a constant-current charging (or CC) operation up to 4.2 V at 1 C, and a discharging condition was set to establish a constant-current (or CC) discharging operation down to 2.5 V at 1 C, at 25° C. or 55° C. The first charging/discharging test after the conditioning treatment was labeled the first cycle, and the identical charging and discharging operations were carried out repeatedly up to the 500th cycle. And, discharge capacities in the respective cycles were calculated relatively to the first-cycle discharge capacities taken as 100, and were labeled discharge-capacity maintenance rates (%). FIG. 1 shows the discharge-capacity maintenance rates when the charging and discharging operations were carried out at 25° C., and FIG. 2 shows the discharge-capacity maintenance rates when the charging and discharging operations were carried out at 55° C., respectively.

The lithium-ion secondary batteries according to Embodiment and Comparative Example, which employed the electrolytic solution including FEC, exhibited such a high discharge-capacity maintenance rate as 80% approximately in the 500th charging and discharging operations at room temperature, respectively (see FIG. 1). That is, when the lithium-ion secondary batteries are employed at 25° C., the cyclability upgrades by employing FEC. On this occasion, the lithium-ion secondary battery according to Comparative Example exhibited better cyclability than did the lithium-ion secondary battery according to Embodiment. Although the two lithium-ion secondary batteries differed one another in that the types of the binding agents included in the negative electrodes were different from each other, the resulting cyclability was not found to decline greatly even when the polyamide-imide resin/silica hybrid was employed in the negative electrode.

On the other hand, the lithium-ion secondary battery according to Reference Example employing the FEC-free electrolytic solution was found from FIG. 2 to be better in the cyclability at high temperature than were the lithium-ion secondary batteries according to Embodiment and Comparative Example employing the FEC-including electrolytic solution. The phenomenon is presumed to occur due to the fact that using the FEC-including electrolytic solution at high temperature led to generating hydrogen fluoride (HF) so that the generated HF had adversely affected the active materials. In other words, since the lithium-ion secondary battery according to Reference Example was free from FEC, hydrogen fluoride derived from FEC did not generate at all, so that the lithium-ion secondary battery exhibited the better cyclability. However, even the lithium-ion secondary batteries according to Embodiment and Comparative Example exhibited sufficient cyclability as a secondary battery, respectively.

In particular, the lithium-ion secondary battery according to Embodiment employing the polyamide-imide resin/silica hybrid binder in the negative electrode exhibited better cyclability than did the lithium-ion secondary battery according to Comparative Example employing the un-hybridized binder in the negative electrode. The phenomenon is presumed to occur due to the fact that hydrogen fluoride had been captured by the silica parts in the polyamide-imide resin/silica hybrid, so that the adverse influence resulting from hydrogen fluoride was reduced.

Moreover, the lithium-ion secondary battery according to Embodiment, and the lithium-ion secondary battery according to Comparative Example were compared with each other as to differences in the cyclability resulting from the temperature difference upon charging and discharging the lithium-ion secondary batteries. When comparing the 500th-cycle discharge-capacity maintenance rates with each other, the discharge-capacity maintenance rate was 82.0% at 25° C., but was declined greatly to 73.4% at 55° C., in the lithium-ion secondary battery according to Comparative Example. On the other hand, in the secondary battery according to Embodiment, even though the 500th-cycle discharge-capacity maintenance rate was 77.2% at 25° C., the magnitude of decline in the discharge capacities resulting from temperature rise is said to be inhibited greatly, because the 500th-cycle discharge-capacity maintenance rate was 75.7% at 55° C. In other words, the lithium-ion secondary battery according to Embodiment not only maintained the cyclability at room temperature, but also was able to inhibit the cyclability from declining when being employed at the high temperature.

1. A secondary battery comprising a positive electrode including a positive-electrode active material, a negative-electrode including a negative-electrode active material, and an electrolytic solution, wherein
said positive electrode and/or said negative electrode includes a binding agent containing an organic/inorganic hybrid material having an organic segment comprising a resin, and an inorganic segment comprising silica, the organic/inorganic hybrid material binding said positive-electrode active material and/or said negative-electrode active material,
said electrolytic solution includes a fluorine-containing cyclic carbonate containing at least one fluorine atom.

2. The secondary battery as set forth in claim 1, wherein
said negative-electrode active material includes a silicon oxide,
said organic/inorganic hybrid material binds said negative-electrode active material at least.

3. The secondary battery as set forth in claim 1, wherein said fluorine-containing cyclic carbonate has a structure in which at least one fluorine atom is bonded to one or more carbon atoms constructing a cyclic structure.

4. The secondary battery as set forth in claim 1, wherein said electrolytic solution includes fluoroethylene carbonate.

5. The secondary battery as set forth in claim 1, wherein said organic/inorganic hybrid material includes one or more members selected from the group consisting of bisphenol type-A epoxy resin-silica hybrids, novolac-type epoxy resin-silica hybrids, acrylic resin-silica hybrids, phenolic resin-silica hybrids, polyimide resin-silica hybrids, soluble polyimide resin-silica hybrids, polyurethane resin-silica hybrids, and polyamide-imide resin-silica hybrids.

6. The secondary battery as set forth in claim 1, wherein said organic/inorganic hybrid material is a cured substance of an alkoxysilyl group-containing compound containing an alkoxysilyl group that has a structure specified by formula (I). 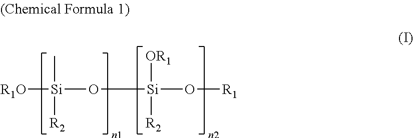
(In Formula (I), “R₁,” “R₂,” “n₁,” and “n₂” respectively stand for the following independently:
“R₁”: an alkyl group whose number of carbon atoms is from 1 to 8;
“R₂”: an alkyl group or alkoxyl group whose number of carbon atoms is from 1 to 8; and
“n₁” and “n₂”: an integer of from 1 to 100)

7. The secondary battery as set forth in claim 6, wherein said alkoxysilyl group-containing compound includes one or more members selected from the group consisting of alkoxy group-containing silane-modified bisphenol type-A epoxy resins, alkoxy group-containing silane-modified novolac-type epoxy resins, alkoxy group-containing silane-modified acrylic resins, alkoxy group-containing silane-modified phenolic resins, alkoxy group-containing silane-modified polyamic acid resins, alkoxy group-containing silane-modified soluble polyimide resins, alkoxy group-containing silane-modified polyurethane resins, and alkoxy group-containing silane-modified polyamide-imide resins.

8. The secondary battery as set forth in claim 1, wherein
said binding agent contains a polyamide-imide resin-silica hybrid whose organic segment comprises polyamide-imide resin,
said electrolytic solution includes fluoroethylene carbonate.
